(19) United States
(12) Patent Application Publication
(10) Pub. No.: US 2018/0008927 A1
(43) Pub. Date: Jan. 11, 2018

(54) AIR FILTERING PIPE

(71) Applicant: George Moussa Makdissi, Northridge, CA (US)

(72) Inventor: George Moussa Makdissi, Northridge, CA (US)

(21) Appl. No.: 15/643,534

(22) Filed: Jul. 7, 2017

Related U.S. Application Data
(60) Provisional application No. 62/359,250, filed on Jul. 7, 2016.

(51) Int. Cl. B01D 46/00; A24F 47/00; B01D 46/18

(52) U.S. Cl. CPC B01D 46/0078; B01D 46/18; A24F 47/002; B01D 46/0005; B01D 46/0032

(57) ABSTRACT

In general, embodiments of the present invention are related to an apparatus and method of use of such apparatus for the personal filtration of air. Particularly, embodiments of this invention relate to the filtration of air for a singular individual to inhale.

### CROSS-REFERENCE TO RELATED APPLICATIONS

This application claims the benefit of U.S. Provisional Patent Application No. 62/359,250 filed on Jul. 7, 2016 and entitled “Air Filtering Pipe”, the entire disclosure of which is hereby incorporated by reference in its entirety.

### FIELD OF INVENTION

The present invention generally relates to an air filtration device and a method for utilizing such device. Specifically, the present invention relates to an air filtration device in the form of a personal and portable apparatus that can assist a user in deep breathing exercises while reducing the user's exposure to environmental pollutants.

### BACKGROUND OF THE INVENTION

Conventional air filtration methods and systems used in daily living usually involve the use of a stationary or fixed mechanism. Accordingly, such mechanisms provide filtration for an atmosphere in an enclosed space. This is subjected to limitations as many individuals find themselves not in an enclosed space throughout the day. On the other hand, conventional air filtration systems that are designed for portability have their own drawbacks in that they cover a large portion of the user's face. This limitation renders the system so uncomfortable that the user would rather not employ such a system, leaving the majority of the population to breathe polluted air.

One source of polluted air is tobacco smoking. Studies have shown that air pollution emitted by cigarettes is ten (10) times greater than diesel car exhaust. The fine particulate matter that is a byproduct of tobacco smoke is deemed the most dangerous element of air pollution. Logically, the best choice one can make in reducing air pollution from tobacco smoke is to refrain from cigarette smoking. However, the addictive properties of cigarette smoking—most notably caused by nicotine dependency—are well documented. To abstain from smoking, there are generally two categories of aids, each with its own drawbacks: (i) nicotine alternatives and (ii) non-nicotine alternatives. Nicotine alternatives—such as gum, patches and vaporizers—do little to nothing to enable a person to free themselves from nicotine dependency. Accordingly, reliance on this method makes one more prone to relapse and resume tobacco smoking. Non-nicotine alternatives include hypnoses, acupuncture and medications. These methods yield skepticism and doubt as they rely primarily on the placebo effect to decrease nicotine dependency.

Accordingly, there exists a need for enabling filtration of environmental air that can quickly and immediately lower the amount of air pollutants and provide a verifiable measure of success in decreasing nicotine dependency. The present invention is provided to solve the problems discussed above and other problems, and to provide advantages and features not provided by currently available air filtration products. These and other features and advantages of the present invention will be explained and will become obvious to one skilled in the art through the summary of the inventions that follow.

### SUMMARY OF INVENTION

Accordingly, the present invention is configured to provide an apparatus for personal air filtration, including methods for using such apparatus. Furthermore, the present invention may be configured to provide a means for assisting a person to rehabilitate a nicotine dependency, especially as it relates to smoking tobacco.

According to embodiments of the current invention, an air filtering apparatus comprising a housing unit that is formed with an inlet and an outlet and configured to retain a fan, a motor, and a power source, and a tubular component that extends from the housing unit and is configured to retain at least one air filtering unit, wherein a first end of the tubular component engages with the outlet of the housing unit.

According to embodiments of the current invention, the air filtering apparatus further comprises a mouthpiece configured to engage with a second end of the tubular component.

According to embodiments of the current invention, the air filtering apparatus further comprises one or more alert means.

According to embodiments of the current invention, the air filtering apparatus further comprises a power control element

According to embodiments of the current invention, the fan is retained within the housing unit below the inlet to draw in air from outside the housing unit and propel said air into said tubular component.

According to embodiments of the current invention, the tubular component is configured to reversibly engage with the outlet of the housing unit.

According to embodiments of the current invention, the tubular component is a straight tube.

According to embodiments of the current invention, forms a straight rigid tube the decreases in circumference from the first end of the tubular component to a second end of the tubular component.

According to embodiments of the current invention, the mouthpiece is configured to reversibly engage with the second end of the tubular component.

According to embodiments of the current invention, the air filtering unit is configured to remove large micron particles of contaminants from environmental air.

According to embodiments of the current invention, the air filtering unit incorporates activated carbon for removal of odors and organic contaminants.

According to embodiments of the current invention, the air filtering unit is reversibly engaged with the tubular component.

According to embodiments of the current invention, the air filtering apparatus comprises of at least one air filtering unit lies between said outlet of the housing unit and the tubular component.

According to an embodiment of the claimed invention, the method of using the air filtering device comprises the steps of (i) turning said air filtering device on; (ii) drawing air from outside said air filtering device and through one or more air filtering units, wherein said air filtering device produces filtered air; (iii) creating a seal with a mouthpiece of said air filtering device, wherein a user wraps their lips around said mouthpiece; and (iv) inhaling the filtered air from said mouth piece.

### BRIEF DESCRIPTION OF THE DRAWINGS

FIG. 1(A) is a side perspective view of an air filtration apparatus in accordance with an embodiment of the present invention;

FIG. 1(B) is side perspective view of an air filtration apparatus illustrating the interior of a housing unit in accordance with an embodiment of the present invention;

FIG. 2 is a cross sectional view of a housing unit of an air filtration apparatus in accordance with an embodiment of the present invention;

FIG. 3 is a cross sectional view of a tubular portion of an air filtration apparatus in accordance with an embodiment of the present invention; and

FIG. 4 is flow chart detailing a method of use of an air filtration apparatus in accordance with an embodiment of the present invention.

### DETAILED DESCRIPTION

The present invention generally relates to an air filtration device and a method of use of such device. Specifically, the device relates to a portable air filtration apparatus that has the functional utility of an air filter but the design feature of a tobacco pipe. The air filtration apparatus is designed to create an accelerated flow of air to be passed through a filtration system for the user to inhale. The portability of a pipe shaped air filter allows the user to inhale large amounts of purified air at the volition of the user. Preferred embodiments of the present invention may be shaped similar to that of a standard pipe in order to enable a hand to mouth movement most smokers are accustomed to.

The method of employing this invention is particularly suited for individuals seeking to quit there dependency of tobacco and nicotine products. However, the method is equally suited for individuals that value breathing clean air, such as for individuals that live in an area contaminated with atmospheric pollution (e.g. a heavily populated city). There are many air pollutants that would be beneficial for a person to avoid including, but not limited to, allergens, bacteria, smoke, and dust. This invention is intended to provide an apparatus that enables a user to inhale clean air even when the environmental air is less than optimal, or even harmful, without a method of filtration, for example when driving behind a truck or bus, when pollen and other airborne allergens are present, or when near a person that is smoking.

According to an embodiment of the present invention, the air filtration device comprises two main pieces. In a preferred embodiment, the first piece of the air filtration device is a housing unit that defines a compartment is configured to retain a fan, motor, power source, and on/off switch or similar power control element. In the preferred embodiment, the fan draws in the surrounding air through an inlet opening located above the fan and forces that air through an outlet opening located on a side of the housing that connects with the second piece of the air filtration device. In the preferred embodiment, the air filtration device is primarily controlled by the on/off switch, but could also be controlled a dial, knob or other interface allowing for variable speeds to be selected and affected by the fan. In a preferred embodiment, the second piece of the air filtration device is a tubular component comprising one or more filtration units. As moving air is pushed through the tubular component, the air is purified by means of such filtration units so that by the time the air reaches the user's mouth, the level of pollutants has been reduced or eliminated.

According to a preferred embodiment of the present invention, components of the air filtering pipe are sized for optimal use. In the preferred embodiment, the housing unit forms a generally cylindrical shape that can be comfortably gripped in a user's hand. The cylindrical shape, which lacks any jarring corners or points, allows for the palm of the user's hand to wrap snuggly around the housing unit, enabling a user to conveniently transport and use the air filtering pipe. Further in the preferred embodiment, the tubular component is straight rather than curved to provide for maximum air flow. In another embodiment, the tubular component will be straight and ridged yet decrease in circumference as it extends away from housing unit.

In a preferred embodiment, centrifugal fan retained within the housing unit draws air from the atmosphere and pushes that air through a tubular component containing a means to remove contaminants and particulates from the air. The purpose of these preferred embodiment is to maximize air flow, provide stability for the user of the air filtering pipe and to increase air density for the user to inhale.

In a preferred embodiment, the air filtering pipe comprises of a filtration means to reduce the odor of smoke, since users may want to join other smokers in outdoor smoking sections to socialize with other smokers. Further, the filtration means will be able to remove various pollutants from the air such as dust, lint, dust mites, pollen, pet dander, mold spores, bacteria, microscopic allergens, odor, most smoke and smog, while maintaining a sufficient volume of air flow to the user. Examples of filtration means include, but are not limited to, filters comprising of cellulose acetate fiber, paper or activated carbon, gauze and similar types of mesh filters.

According to embodiments of the current invention, there is an air filtration unit between the housing unit and the tubular component. Such unit (without limitation) may be in the form of a mesh filter such as gauze. In some embodiments, the air filtration unit is on the inside of the housing unit upon the outlet connecting to the tubular component. In other embodiments, the air filtration unit is outside the housing unit upon the outlet. Still, in other embodiments, there are multiple air filtration units on both sides of the outlet.

In a preferred embodiment, two pieces, the housing and tubular component, when connected together resemble the appearance of a standard pipe. This embodiment provides the user a portable, convenient, and familiar means to inhale when the user desires to inhale. Advantageously, this design brings familiarity to an unfamiliar idea. This being the idea that one can inhale clean and harmless air, while still being a part of the smoker community.

Alternate embodiments of the current invention employ other geometric shapes for the housing unit including, but not limited to polygonal, spheroid, and cubical form. Similarly, in alternative embodiments, the tubular component that attaches to the housing unit may be, but is not limited to, other configurations such as curved, twisted, angled or otherwise nonlinear shape. One of ordinary skill in the art would appreciate that there are numerous geometrical configurations that could be used for the various components of the air filtering pipe, and embodiments of the present invention are contemplated for use with any appropriate alternative design or construction alternative.

### Exemplary Embodiments

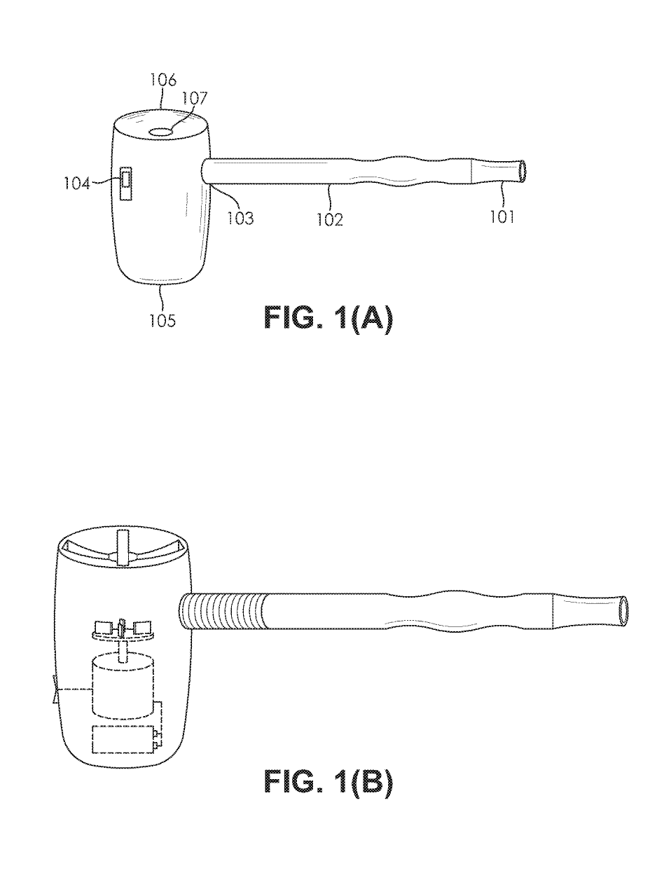

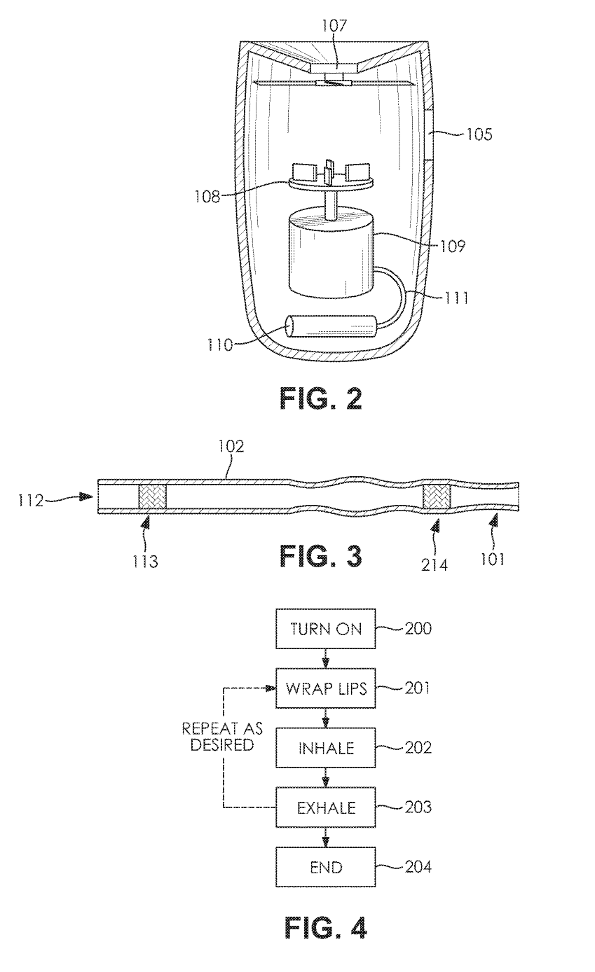

Referring to FIG. 1(A), an exemplary embodiment of an air filtering pipe is shown. In this figure, a mouthpiece 101 is shown attached to the hollow tubular component 102. The tubular component 102 is connected to an entry point 103 on a housing component 105. Entry point 103 is one of two openings that is part of housing component 105. Housing component 105 is configured to draw in surrounding air through a housing opening 107 and push air into the entry point 103, and through the tubular component 102. Power switch 104 is used to activate the air filtering pipe. Cap 106 is designed to channel surrounding air to the housing opening 107, a small circular opening in which air from the atmosphere can pass into the housing component 105. FIG. 1(B) shows the internal components of the housing component as detailed in FIG. 2.

Referring to FIG. 2, an exemplary embodiment of a housing component 105. Directly below the cap 106 is a fan 108 (e.g., centrifuge fan) propelled by a motor 109 configured to draw in surrounding air and push the air through the entry point 103 into the tubular component. The motor 109 is powered by a power source 110 (e.g., battery unit) located directly below the motor 109. An electrical connection 111 supplies electricity from the power source 110 to the motor 109. A power control element (not), such as a switch, is used by the user to activate and deactivate the air filtering pipe. While the configuration herein is appropriate for a preferred embodiment of the present invention, one of ordinary skill in the art would appreciate that many of the components, such as the fan 108, motor 109, power source 110 and power control element (not shown), could be replaced with other components capable of serving the same or similar functionality, and embodiments of the present invention are contemplated for use with any such optional components.

Referring to FIG. 3, the tubular component 102 of the air filtering pipe comprises a first opening 112 that connects with the entry point (not shown) on the housing unit. The connection will enable the air being drawing into the housing unit by the fan to be propelled to the user via the tubular component 102. As air gets pushed through the opening 112, it will pass through a first air filter 113 that removes pollutants from the flowing air. In alternate embodiments, there is a second air filter 214 that also provides a means to remove pollutants that the first air filter 113 failed to remove. In a preferred embodiment, the tubular component 102, through which the air flows to the user, will be hollow, semi-rigid and transparent. A mouthpiece 101 is affixed to the tubular component 102 opposite the housing unit. In some embodiments the mouthpiece 101 comprises of a smaller circumference than the tubular component in order to condense the passing air for the user to inhale. In alternate embodiments, the tubular component extends into the mouthpiece. In the preferred embodiment, the mouthpiece 101 is formed from a durable, yet pliable, material that is designed to provide comfort for the user. Ideally, the user is able to wrap their lips around the mouthpiece 101 and pinch the mouthpiece 101 with their lips in order to control the amount of air flow that the user inhales.

In the preferred embodiment, the housing unit 105 and tubular component 102 are affixed in an irreversible manner. However in alternate embodiments, the housing unit 105 and tubular component 102 are configured to be detachable, as this allows for the replacement of the air filters and facilitates transportability. In further alternate embodiments, the mouthpiece 101 on the tubular component 102 is also detachable to allow for the mouthpiece 101 to be replaced when necessary. Similarly, the preferred embodiment has one or more permanent air filters. These permanent air filters may be cleaned as necessary. Alternatively, other embodiments of the tubular component 102 employ removable air filters that may be replaced as necessary.

Referring to FIG. 4, a preferred method of using the claimed apparatus. At step 200, the user activates the fan of the air filtering apparatus. At step 202 the user wraps his/her lips around the mouthpiece, then inhales 203 the filtered air, and finally exhales normally 204. The process is repeated as many times as the user feels is necessary until the process ends 205.

In addition to generating purified air for the user, the claimed invention can also assist the user to quit consuming tobacco. The mechanism of inhaling purified air will create a similar hand to mouth motion that is familiar to smokers and recognized as a form of oral fixation. Additionally, the product allows the user to expand and deepen his/her breath to open the lungs and replenish the oxygen in the user's body that has been diminished from consuming tobacco and nicotine products. Deep breathing has been shown to assist in alleviating anxiety and cravings felt by the user. By inhaling clean air, the product instills an idea of healthy living, free from the harmful chemicals that one would inhale from tobacco and nicotine products. By inhaling large amounts of purified air, the user can achieve numerous health benefits such as anxiety relief, higher oxygen levels in the body, and increase a user's energy. The idea is to replace the hand to mouth oral fixation a smoker is accustomed to with something that is beneficial to a person's health. Without using nicotine, this product can help smokers learn that inhaling smoke and chemicals is not necessary.

According to an embodiment of the present invention, additional components may be incorporated into the air filtration device to enhance the benefits of exercise. In a preferred embodiment, the air filtering pipe incorporates a means to communicate to the user how long they should be inhaling for specific breathing exercises and/or to track how long a user inhaled in the past to motivate a user to attempt to inhale longer. Such communication means may include, but are not limited to, audible alert means (e.g., buzzers, speaker), visual alert means (e.g., LED indicator light), or any combination thereof. One of ordinary skill in the art would appreciate that there are numerous communication means that could be utilized with embodiments of the present invention, and embodiments of the present invention are contemplated for use with any appropriate means to communicate.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

1. An air filtering apparatus comprising:
a housing unit that is formed with an inlet and an outlet and configured to retain a fan, a motor, and a power source; and
a tubular component that extends from the housing unit and is configured to retain at least one air filtering unit, wherein a first end of the tubular component engages with the outlet of the housing unit.

2. The air filtering apparatus of claim 1, further comprising a mouthpiece configured to engage with a second end of the tubular component.

3. The air filtering apparatus of claim 1, further comprising a power control element.

4. The air filtering apparatus of claim 1, further comprising one or more alert means.

5. The air filtering apparatus of claim 1, wherein said fan is retained within the housing unit below the inlet to draw in air from outside the housing unit and propel said air into said tubular component.

6. The air filtering apparatus of claim 1, wherein the tubular component is configured to reversibly engage with the outlet of the housing unit.

7. The air filtering apparatus of claim 1, wherein the tubular component a straight tube.

8. The air filtering apparatus of claim 1, wherein the tubular component forms a straight rigid tube the decreases in circumference from the first end of the tubular component to a second end of the tubular component.

9. The air filtering apparatus of claim 1, wherein the mouthpiece is configured to reversibly engage with the second end of the tubular component.

10. The air filtering apparatus of claim 1, wherein the air filtering unit is configured to remove large micron particles of contaminants from environmental air.

11. The air filtering apparatus of claim 1, wherein the air filtering unit incorporates activated carbon for removal of odors and organic contaminants.

12. The air filtering apparatus of claim 1, wherein the air filtering unit is reversibly engaged with the tubular component.

13. The air filtering apparatus of claim 1, wherein at least one air filtering unit lies between said outlet of the housing unit and the tubular component.

14. A method of using an air filtering device comprising the steps of:
turning said air filtering device on;
drawing air from outside said air filtering device and through one or more air filtering units, wherein said air filtering device produces filtered air;
creating a seal with a mouthpiece of said air filtering device, wherein a user wraps their lips around said mouthpiece; and
inhaling the filtered air from said mouth piece.
